(19) United States
(12) Patent Application Publication
(10) Pub. No.: US 2004/0047965 A1
(43) Pub. Date: Mar. 11, 2004

(54) Milk product and process for its prouduction

(76) Inventors: Rudolf Haindl, Salzburg (AT); Hans Mandl, Pfunds (AT)

Correspondence Address: Mark D. Lorusso, Lorusso & Loud, 440 Commercial Street, Boston, MA, 02109, US

(21) Appl. No.: 10/655,885

(22) Filed: Sep. 5, 2003

Related U.S. Application Data
(63) Continuation of application No. PCT/AT02/00066, filed on Mar. 5, 2002.

(30) Foreign Application Priority Data
Mar. 5, 2001 (AU) 340/2001

(51) Int. Cl. A23L 1/05

(52) U.S. Cl. 426/573

(57) ABSTRACT

The invention relates to a structurally reversible dairy product, which is made from cream, low-fat milk or water in addition to gelling agents, whereby the gelling agents comprise exclusively raw vegetable materials, preferably vegetable hydrocolloids, preferably carrageen, cellulose, konjac and alginate.

### CROSS-REFERENCE TO RELATED APPLICATIONS

This is a continuation of International Application PCT/AT02/00066, with an international filing date of March 5, 2002, now abandoned.

The invention relates to a milk product which consists essentially, preferably exclusively, of cream, skimmed milk or water, and also gelling agent. The invention also relates to several processes for the production of the milk product according to the invention.

Such a milk product is described in EP 1 086 625. With this known milk product, the gelling agent contains i.a. gelatin produced from cowhide. Due to the ever-increasing incidence of BSE cases in recent times, consumer scepticism with regard to foods which contain bovine products has vastly increased with the result that the sales figures for such food products have in some cases fallen dramatically.

An object of the invention is to provide a novel milk product which has the same properties as the milk products produced according to the state of the art, but which avoids the use of gelatin produced from cowhide.

This is achieved according to the invention in that the gelling agent contains exclusively vegetable raw materials, preferably vegetable hydrocolloids. The advantage of this novel milk product is therefore primarily that the use of gelatin which is produced from animal products can be completely dispensed with this novel milk product, however having the same properties as the conventional milk products produced with gelatin, i.e. being structure-reversible. In this context, structure-reversible means that the finished milk product has a gel structure which, if destroyed by shearing forces such as e.g. when stirred with a whisk or in the mixer, forms anew. This is important inasmuch as the novel milk product can be used as a semifinished product only as a result of this property. In particular this is because the novel milk product, even upon setting of a pH value below 5 (ph<5), for example by the addition of acid components, remains structure-reversible, i.e. is acid-stable.

Tests by the applicant have shown that the novel milk product, because of these two properties, namely the structure-reversibility and the acid-stability, has a further property important for its use as semifinished product, namely that it is or remains temperature-stable. The products known to date, due to their non-reversible gel structure and due to the fact that they coagulate upon addition of acid or upon exposure to shearing forces, had no freezing and thawing stability, for which reason the use of such milk products as semifinished product was not possible.

It has proved favourable for the formation of the gel structure for the gelling agent to be a mixture of carrageen, cellulose and pectin. As a result of the negatively charged sulphate groups, the carrageen can react with the proteins of the skimmed milk. In order to avoid the coagulation of the iota and/or kappa carrageen below a pH of 4.8, cellulose, preferably physically or chemically treated cellulose, is used as protective colloid. Thus, a gel structure can form which is freezing/thawing-stable and which behaves after thawing in exactly the same way as before freezing. In order to improve the formation of the new gel structure after destruction by shearing forces, pectin or konjac flour is used. In addition, sodium caseinate can be admixed as buffer to the gelling agent.

Furthermore it has proved particularly advantageous for the increasing of the oil absorbency for the gelling agent to also contain alginate. Only through the use of alginate is it possible for the oil, upon stirring into the milk product, to form a compound with same, i.e. for the oil not to separate again from the milk product.

It has proved particularly favourable for the consistency and keeping quality of the novel milk product for at least 70% cream to be used and for the proportion of gelling agent to be between 0.9% and 3%, preferably 1.1%.

Furthermore a process for the production of this novel milk product is to be provided.

It has proved particularly favourable for the mixing of the gelling agent with the skimmed milk and thus for the formation of a gel structure for the powdery gelling agent to be stirred into skimmed milk or water in a mixing tank, the skimmed milk or the water having a temperature between 3 and 10° C., preferably between 5 and 7° C., for this mixture to then be left to swell and then be mixed with the remaining ingredients. Vegetable raw materials which form the gelling agent when the fat content of the skimmed milk is below 0.3%, preferably below 0.1%, provide particularly good development possibilities.

So that the novel milk product has a preferred fat content of approximately 15%, it is provided according to a further version that the fat content of the cream used is approximately 36%. This circumstance, together with a further aspect of the invention, namely that the pH value of the mixture of all ingredients is between 6.5-7.5, preferably 6.7, results in the end-product being neutral in taste. For a long unrefrigerated keeping quality of the end-product it is particularly advantageous to briefly heat the mixture, containing at least cream and gelling agent enriched with skimmed milk, to a temperature above 130° C. before pouring into the pack and to homogenize it, wherein it has proved particularly favourable if the homogenization is carried out at a temperature below 100° C. and a pressure between 185 bar and 250 bar, preferably in one stage. It is preferably provided that the pouring temperature of the mixture, containing at least cream and gelling agent enriched with skimmed milk, is between 30° C. and 60° C., it having transpired that a demixing or flocculation of the gelling agent can be avoided if the milk product is rapidly cooled, after pouring, to a temperature below 25° C., preferably below 15° C.

A further process for the production of this novel milk product is characterized in that all the ingredients are introduced into a colloid mill, preferably a toothed colloid mill, mixed there and this mixture is then left to swell. In this process also, a skimmed milk with a fat content preferably below 0.1%, and also cream with a fat content of approximately 36% is used. Likewise the pH value of the mixture of all ingredients is between 6.5-7.5, preferably 6.7%.

In contrast to the previously described process, it is sufficient with this process to heat the mixture, containing at least cream and gelling agent enriched with skimmed milk, to a temperature between 85 and 110° C., preferably 100° C., before pouring into the pack in order to enable the milk to keep for a long time unrefrigerated. To obtain a uniform size and distribution of the fat particles, it can be provided according to this embodiment that the homogenization takes place at a temperature of approximately 100° C. and a pressure between 4 and 7 bar, preferably between 5 and 6 bar. After the mixture, containing at least cream and gelling agent enriched with skimmed milk, has been poured at 100° C., it is advantageous, to avoid a demixing or a flocculation of the gelling agent, if the milk product is rapidly cooled to a temperature below 25° C., preferably below 15° C., after pouring.

The invention will be explained in more detail hereafter using a preferred embodiment with reference to the drawing. There are shown in

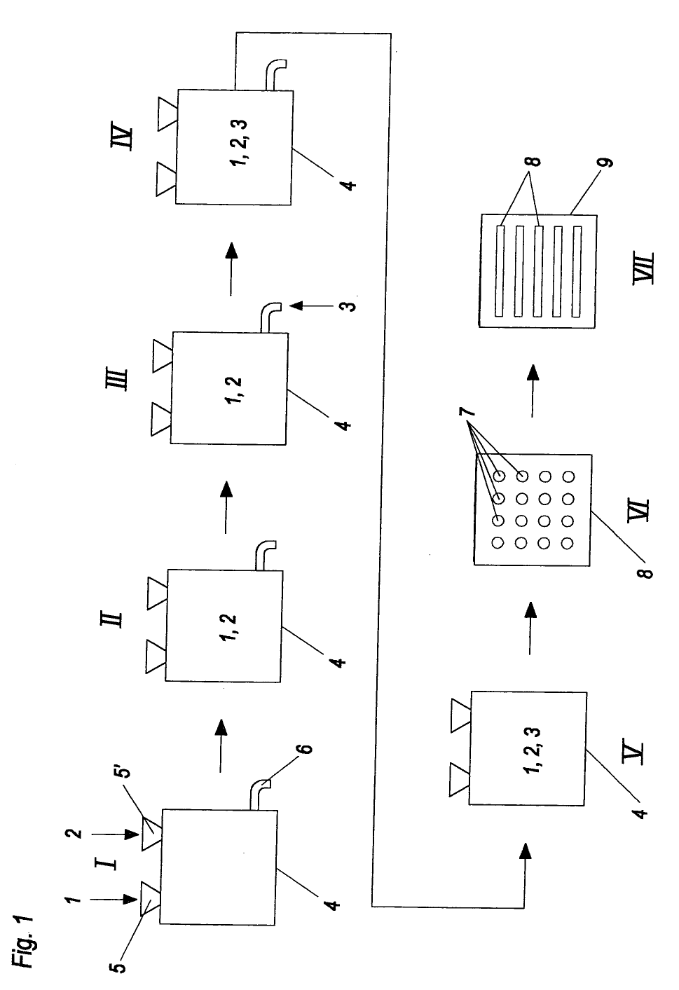

FIG. 1 a schematic representation of a procedure using the process according to the invention,

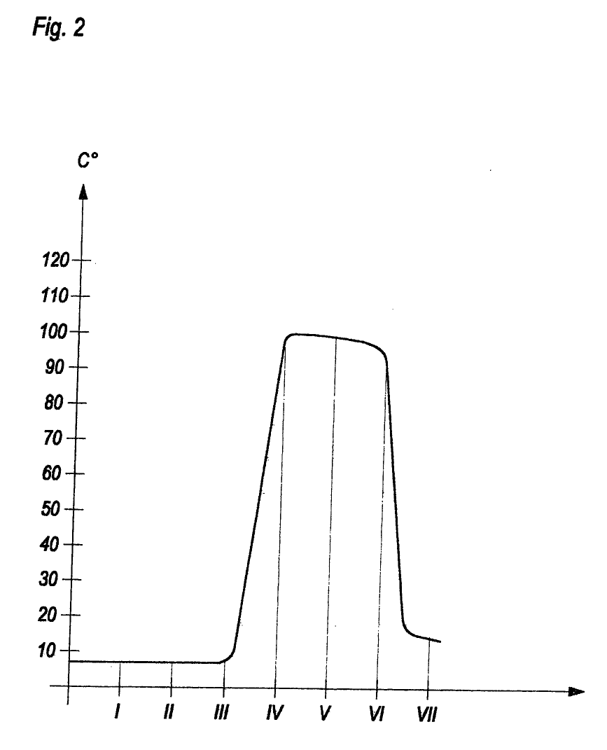

FIG. 2 the approximate temperature pattern during the individual process steps according to FIG. 1.

In step 1, skimmed milk 1 is introduced into a toothed colloid mill 4, for example of the Fryma Koruma Delemix type, via a funnel 5 and gelling agent 2 via a funnel 5′. The gelling agent 2 is a mixture of iota-carrageenan (E 407), carboxymethylcellulose (E 466), pectin type C-1828 (E 440) and Na alginate (E 401). A further embodiment provides that the gelling agent is produced exclusively from carrageen, cellulose, konjac flour and alginate, the carrageen being a mixture of iota-carrageenan and kappa-carrageenan. In this case, the gelling agent is composed of 22% iota- and kappa-carrageenan, 26% cellulose, 26% konjac flour and 26% Na alginate. In addition, Na caseinate can be admixed to the gelling agent as buffer, the Na caseinate content of the gelling agent being approx. 10.5%.

In step II, the skimmed milk 1 is thoroughly mixed with the gelling agent 2 at approx. 5 to 7° C. and left to swell for approx. 5 to 10 minutes accompanied by gentle stirring. In the next step III cream 3 is admixed to this mixture at a temperature of approx. 5° C. via a suction pipe 6.

After all ingredients 1, 2 and 3 have been mixed in the toothed colloid mill 4, this mixture, which has a temperature between 5 and 7° C. and also a fat content of approx. 15%, is heated to 100° C. in step IV for approx. three minutes and subsequently homogenized in step V at approx. 100° C. and a pressure of approximately 5 to 6 bar in the sterile region. This mixture is then poured into the pack 7 in step VI and stored in pallets 8. In the next step VII of the process these pallets 8 are rapidly cooled to a temperature below 25° C., preferably 15° C., in the cold-storage room 9 and stored there at 5 to 6° C. for approx. 7 to 10 days.

1. Structure-reversible milk product which consists essentially, preferably exclusively, of cream, skimmed milk or water, and also gelling agent, characterized in that the gelling agent contains exclusively vegetable raw materials, preferably vegetable hydrocolloids.

2. Milk product according to claim 1, characterized in that it remains structure-reversible, even upon setting of a pH value below 5 (ph<5), for example by the addition of acid components.

3. Milk product according to one of claims 1 to 2, characterized in that it is or remains temperature-stable.

4. Milk product according to one of claims 1 to 3, characterized in that the gelling agent is a mixture of carrageen, cellulose, and also pectin or konjac flour.

5. Milk product according to claim 4, characterized in that the gelling agent also contains alginate.

6. Milk product according to claims 4 and 5, characterized in that the gelling agent is produced exclusively from carrageen, cellulose, konjac flour and alginate.

7. Milk product according to claims 4 to 6, characterized in that the carrageen is a mixture of iota-carrageenan and kappa-carrageenan.

8. Milk product according to claims 1 to 7, characterized in that the carrageen content of the gelling agent is between 19% and 25%, preferably 22%, the cellulose content between 21% and 31%, preferably 26%, the konjac flour content between 21% and 31%, preferably 26%, and the alginate content between 21% and 31%, preferably 26%.

9. Milk product according to one of the previous claims, characterized in that the gelling agent also contains sodium caseinate, the sodium caseinate content of the gelling agent being between 8% and 12%, preferably 10%.

10. Milk product according to one of claims 1 to 9, characterized in that it contains at least 70%, preferably 90% cream.

11. Milk product according to one of claims 1 to 10, characterized in that the gelling agent content is between 0.9% and 3%, preferably approx. 1.1%.

12. Milk product according to one of claims 1 to 11, characterized in that the fat content is between 5% and 15%.

13. Process for the production of a milk product according to one of claims 1 to 12, characterized in that the powdery gelling agent is stirred into skimmed milk or water in a mixing tank, the skimmed milk or the water having a temperature between 3° and 10° C., preferably between 5° and 7°, this mixture is then left to swell and then mixed with the remaining ingredients.

14. Process according to claim 13, characterized in that the fat content of the skimmed milk is below 0.3%, preferably below 0.1%.

15. Process according to one of claims 13 to 14, characterized in that the fat content of the cream used is approx. 36%.

16. Process according to one of claims 13 to 15, characterized in that the pH value of the mixture of all ingredients is between 6.5-7.5, preferably between 6.7.

17. Process according to one of claims 13 to 16, characterized in that the mixture, containing at least cream and gelling agent enriched with skimmed milk, is briefly heated to a temperature above 130° C. before being poured into the pack, and is homogenized.

18. Process according to claim 17, characterized in that the homogenization is carried out at a temperature below 100° C. and a pressure between 185 bar and 215 bar, preferably in one stage.

19. Process according to one of claims 13 to 18, characterized in that the pouring temperature of the mixture, containing at least cream and gelling agent enriched with skimmed milk, is between 30° C. and 40° C.

20. Process according to one of claims 13 to 19, characterized in that the milk product is rapidly cooled to a temperature below 25° C., preferably below 15° C., after pouring.

21. Process for the production of a milk product according to one of claims 1 to 12, characterized in that all ingredients are introduced into a colloid mill, preferably a toothed colloid mill, and mixed there, and this mixture is then left to swell.

22. Process according to claim 21, characterized in that the fat content of the skimmed milk is below 0.3%, preferably below 0.1%.

23. Process according to one of claims 21 to 22, characterized in that the fat content of the cream used is approx. 36%.

24. Process according to one of claims 21 to 23, characterized in that the pH value of the mixture of all ingredients is between 6.5-7.5, preferably 6.7.

25. Process according to one of claims 21 to 24, characterized in that the mixture, containing at least cream and gelling agent enriched with skimmed milk, is heated to a temperature between 85° C. and 110° C., preferably 100° C., before being poured into the pack and homogenized.

26. Process according to one of claims 21 to 25, characterized in that the homogenization takes place at a temperature of approx. 100° C. and a pressure between 4 bar and 7 bar, preferably between 5 and 6 bar.

27. Process according to one of claims 21 to 26, characterized in that the pouring temperature of the mixture, containing at least cream and gelling agent enriched with skimmed milk, is approximately 100° C.

28. Process according to one of claims 21 to 27, characterized in that the milk product is rapidly cooled to a temperature below 25° C., preferably 15° C., after being poured.
